(19) United States
(12) Patent Application Publication
(10) Pub. No.: US 2022/0196293 A1
(43) Pub. Date: Jun. 23, 2022

(54) METHOD FOR MOLDING REVOLUTION PARABOLOID CONDENSER

(71) Applicant: Harbin Institute of Technology, Harbin (CN)

(72) Inventors: Lifang Li, Harbin (CN); Pengzhen Guo, Harbin (CN); Rongqiang Liu, Harbin (CN); Zongquan Deng, Harbin (CN); Heng Li, Harbin (CN); Hongwei Guo, Harbin (CN); Juncai Wang, Harbin (CN)

(21) Appl. No.: 17/522,636

(22) Filed: Nov. 9, 2021

(30) Foreign Application Priority Data
Dec. 21, 2020 (CN) 202011517745.7

(51) Int. Cl. F24S 23/70; F24S 23/71; G02B 5/10; G02B 19/00

(52) U.S. Cl. CPC F24S 23/82; G02B 19/0042; G02B 5/10; F24S 23/71

(57) ABSTRACT

A method for molding a revolution paraboloid condenser, belongs to the field of condenser molding. The problems in the existing revolution paraboloid condensers, of high cost, difficult processing, and difficult assembly and transportation due to a complex overall structure are solved. The method includes determining a revolution paraboloid function of the condenser designed, determining a number of laminated structures that make up the condenser, and determining width functions of the laminated structures; deducing variable-thickness functions of the laminated structures; connecting multiple basic thin plate units in sequence to form each of the laminated structures; the multiple laminated structures are formed into a circle; punching holes in uppermost layers of the laminated structures, passing a rope through the holes and fixing other end of the rope to the vertical rod positioned at the center of the circle.

### CROSS REFERENCE TO RELATED APPLICATION

This patent application claims the benefit and priority of Chinese Patent Application No. 202011517745.7, entitled “Method for molding revolution paraboloid condenser” filed with the Chinese Patent Office on Dec. 21, 2020, which is incorporated herein by reference in its entirety.

### TECHNICAL FIELD

The present disclosure belongs to the field of condenser molding, and in particular relates to a method for molding a revolution paraboloid condenser.

### BACKGROUND

Solar energy is clean and sustainable new energy. However, an energy density of solar radiation reaching the earth is relatively low. To make full use of the solar energy, it is desirable to focus the sunlight to improve the utilization efficiency. A revolution paraboloid condenser is one of the most commonly used methods to improve the solar energy collection efficiency. However, as for a large-scale high-precision revolution paraboloid condenser, the manufacturing cost is too high, the processing is very difficult, and the assembly and transportation are also inconvenient. Moreover, in terms of accuracy, it tends to be costly to achieve a higher accuracy. Therefore, it is urgently desired to reduce the cost, simplify the structure, and improve the overall accuracy for manufacturing large-scale solar condenser.

### SUMMARY

In order to solve the problems in the prior art, the embodiments provide a method for molding a revolution paraboloid condenser.

In order to achieve the foregoing objective, the embodiments adopt the following technical solutions: a method for molding a revolution paraboloid condenser, including the following steps:

step 1: determining a revolution paraboloid function of the condenser designed, determining a number of laminated structures that make up the condenser, and determining width functions of the laminated structures;

step 2: based on an elastic large deformation theory, Euler-Bernoulli equation and a virtual displacement theorem, deducing variable-thickness functions of the laminated structures, and obtaining a thickness curve of the variable-thickness function through numerical analysis;

step 3: discretizing the variable-thickness function which is a continuous function to be converted into multiple sub-functions respectively characterizing multiple basic thin plate units, which have equal thickness, regularly change, and are connected in sequence to form each of the laminated structures; and obtaining numerical solutions of the laminated structures in a stiffener shape;

step 4: attaching a highly reflective material to a working surface of each of the laminated structures;

step 5: arranging and fixing corner points of the laminated structures on a base support layer, such that the multiple laminated structures are formed into a circle, and fixing a vertical rod at a center of the circle; and

step 6: punching holes in uppermost layers of the laminated structures, passing a rope through the holes and fixing other end of the rope to the vertical rod positioned at the center of the circle; and adjusting a length of the rope to bend the laminated structure into a revolution paraboloid.

Further, in step 1, the width functions of the laminated structure may be determined by projecting unfolded areas of curved surfaces of the laminated structures.

Further, a stiffness function of a variable cross-section mathematical model of the revolution paraboloid laminated structure may be established according to the revolution paraboloid function and the width functions of the laminated structures in the step 1 to obtain the variable-thickness functions of the laminated structures.

Further, the stiffness function may be divided into two parts for processing, i.e., a composite bending moment acting on an end of each of the laminated structures and a final curvature of each of the laminated structures are, respectively processed.

Further, the uppermost layers of the laminated structures may be working surfaces.

Further, the basic thin plate units may be cut by a water jet cutter.

Further, the basic thin plate units that regularly change may be connected by bonding with epoxy resin.

Further, the highly reflective material can be a 3M ESR high-reflectivity double-sided silver reflection optical film.

Further, the number of the laminated structures may be equal to or greater than two, more preferably, the number of the laminated structures may be equal to or greater than six.

Further, the number of the basic thin plate units may be equal to or greater than three.

Compared with the prior art, the beneficial effects of the embodiments can include: the embodiments solve the problems in the existing revolution paraboloid condensers of high cost, difficult processing, and difficult assembly and transportation due to a complex overall structure Aiming at the problem that it is difficult to process metal sheets with continuously varying thicknesses in a revolution paraboloid condenser, the embodiments provide the laminated structure, and the continuous thickness function is discretized into several sub-functions respectively characterizing equal-thickness metal basic thin plate units that regularly change in shape, which changes the problem of processing a continuously varying thickness into the problem of processing thin metal plates with regularly changing shapes, greatly reducing the difficulty of processing. The several metal basic thin plate units can be processed at the same time, which greatly saves processing time. The processing time is reduced and the processing difficulty is reduced, thereby further greatly reducing the cost of the whole process of the revolution paraboloid condenser.

### BRIEF DESCRIPTION OF THE DRAWINGS

FIG. 1 is a schematic three-dimensional structural diagram of a revolution paraboloid condenser of the present disclosure;

FIG. 2 is a schematic top structural diagram of a laminated structure according to the present disclosure when the number of the laminated structures is eight without bending;

FIG. 3 is a schematic structural diagram of a first basic thin plate unit layer according to the present disclosure;

FIG. 4 is a schematic structural diagram of a second basic thin plate unit layer according to the present disclosure;

FIG. 5 is a schematic structural diagram of a third basic thin plate unit layer according to the present disclosure;

FIG. 6 is a schematic structural diagram of a fourth basic thin plate unit layer according to the present disclosure;

FIG. 7 is a schematic structural diagram of a fifth basic thin plate unit layer according to the present disclosure;

FIG. 8 is a schematic overall structural diagram of the laminated structures according to the present disclosure;

FIG. 9 is a schematic overall deformation structural diagram of the laminated structures according to the present disclosure; and

FIG. 10 is a schematic flow diagram of a method molding revolution paraboloid condenser according to the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure.

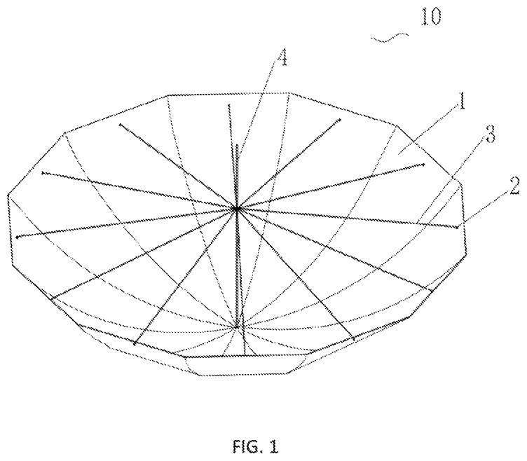

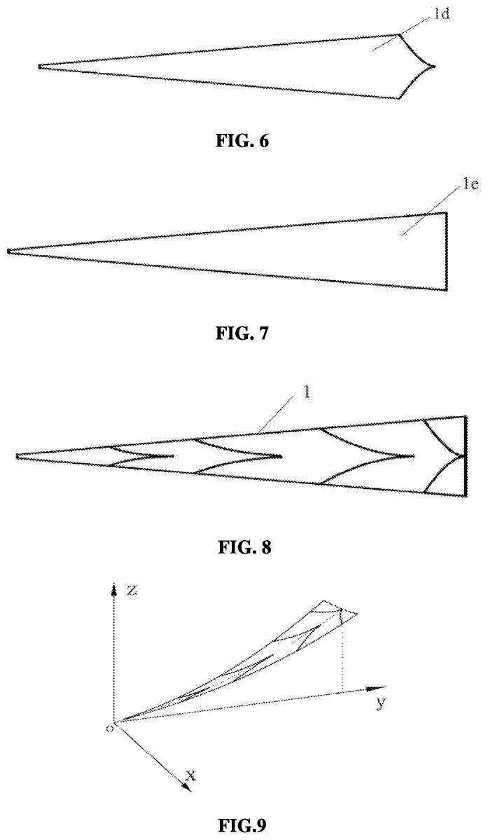

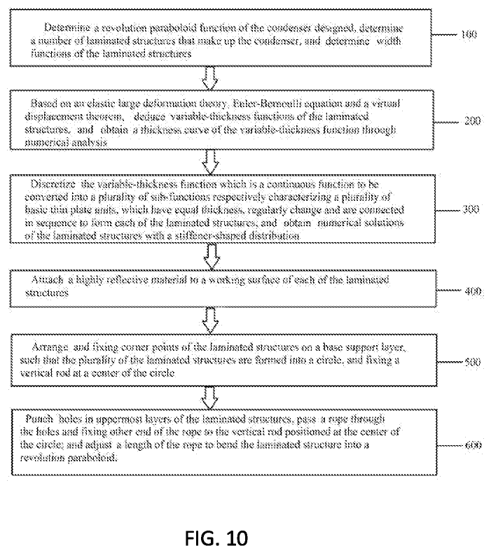

An embodiment is illustrated with reference to FIGS. 1-10, providing a method for molding a revolution paraboloid condenser 10, including the following steps as illustrated, for example, in FIG. 10.

In step 1, a revolution paraboloid function of the designed condenser, the number of laminated structures 1 that make up the condenser (as illustrated in FIG. 1), and a width function of the laminated structure 1 are determined (block 100).

In step 2, based on an elastic large deformation theory, Euler-Bernoulli equation and a virtual displacement theorem, variable-thickness functions of the laminated structure 1 are deduced, and a thickness curve of the variable-thickness function (as illustrated in FIG. 9) is obtained through numerical analysis (block 200).

In step 3, a continuous variable-thickness function is discretized to convert into multiple sub-functions respectively characterizing equal-thickness basic thin plate units 1a, 1b, 1c, 1d, 1e, (as illustrated in FIGS. 3-7) which have equal thickness, regularly change, and are connected in sequence to form each of the laminated structure 1, (as illustrated in FIG. 8) and obtain a stiffener shape numerical solution of the laminated structure 1 (block 300).

In step 4, a highly reflective material is attached to a working surface of the laminated structure 1 (block 400).

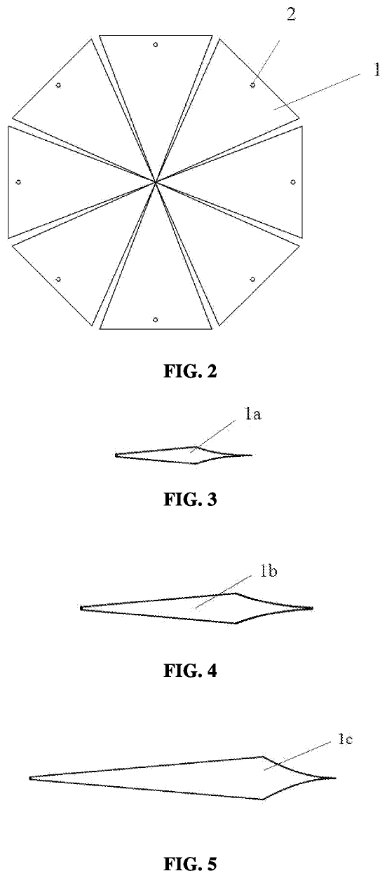

In step 5, the corner points of multiple laminated structures 1 are arranged on a base support layer and fixed thereon, so that the multiple laminated structures 1 are formed into a circle (as illustrated in FIG. 2), and a vertical rod 4 is fixed at the center of the circle, as illustrated in FIG. 1 (block 500).

In step 6, the uppermost layer of the laminated structure 1 is perforated, a rope (or other member) 3 is passed through holes 2 and the other end of the rope 3 is fixed to the vertical rod 4 positioned at the center of the circle. and the length of the rope 3 is adjusted so that the laminated structure 1 is formed into a revolution paraboloid (block 600).

The number of the laminated structures 1 in this embodiment can be equal to or greater than six, and the number of the laminated structures 1 in this embodiment is eight. The number of the basic thin plate units is equal to or greater than three, and is five in this embodiment. For the laminated structure 1, the number of laminated structures 1 is determined by calculating a relationship among the energy gathering efficiency, the number of laminated structures 1, a focusing diameter, and an aperture of the condenser. The number of the basic thin plate units is determined by a maximum thickness value obtained in the step 2 and thicknesses of the basic thin plate units. The width function of the laminated structure 1 in the step 1 is determined by projecting the unfolded areas of curved surfaces of the laminated structures 1. A stiffness function of a variable cross-section mathematical model of the revolution paraboloid laminated structure 1 is established according to the revolution paraboloid function and the width function of the laminated structure 1 in the step 1 to obtain the variable-thickness function of the laminated structure 1. The stiffness function is divided into two parts for processing, i.e., a composite bending moment acting on an end of the laminated structure 1 and a final curvature of the laminated structure 1 are respectively processed. The uppermost layer of the laminated structure 1 is the working surface, i.e., the first layer of basic thin plate unit 1a or the fifth layer of basic thin plate unit 1e in this embodiment. The equal-thickness basic thin plate units 1a, 1b, 1c, 1d, 1e are cut by a water jet cutter. The several equal-thickness basic thin plate units 1a, 1b, 1c, 1d, 1e that regularly change are connected by bonding with epoxy resin. Preferably, the highly reflective material can be a 3M ESR (Enhanced Specular Reflecto) high-reflectivity double-sided silver reflection optical film.

The method for molding a revolution paraboloid condenser 10 is described in detail above. Specific examples are used herein to illustrate the principles and implementations of the present disclosure. The descriptions of the foregoing embodiments are only for assisting understanding the method and core idea of the present disclosure. In the mean time, there will be some modifications to the specific implementations and scope of application according to the spirit of the present disclosure for those skilled in the art. In summary, the content of the specification should not be construed as limitations on the scope of the present disclosure.

What is claimed is:

1. A method for molding a revolution paraboloid condenser, comprising:
determining a revolution paraboloid function of the condenser designed, determining a number of laminated structures that make up the condenser, and determining width functions of the laminated structures;
determining, based on an elastic large deformation theory, Euler-Bernoulli equation and a virtual displacement theorem, determining variable-thickness functions of the laminated structures, and obtaining a thickness curve of the variable-thickness function through numerical analysis;
discretizing the variable-thickness function which is a continuous function to be converted into a plurality of sub-functions respectively characterizing a plurality of basic thin plate units, which have equal thickness, regularly change and are connected in sequence to form each of the laminated structures; and obtaining numerical solutions of the laminated structures with a stiffener-shaped distribution;
attaching a highly reflective material to a working surface of each of the laminated structures;
arranging and fixing corner points of the laminated structures on a base support layer, such that the plurality of the laminated structures are formed into a circle, and fixing a vertical rod at a center of the circle; and
punching holes in uppermost layers of the laminated structures, passing a rope through the holes and fixing other end of the rope to the vertical rod positioned at the center of the circle; and adjusting a length of the rope to bend the laminated structure into a revolution paraboloid.

2. The method for molding the revolution paraboloid condenser according to claim 1, wherein in the determining the revolution paraboloid function, the width functions of the laminated structures are determined by projecting unfolded areas of curved surfaces of the laminated structures.

3. The method for molding the revolution paraboloid condenser according to claim 1, wherein a stiffness function of a variable cross-section mathematical model of the revolution paraboloid laminated structure is established according to the revolution paraboloid function and the width functions of the laminated structures to obtain the variable-thickness functions of the laminated structures.

4. The method for molding the revolution paraboloid condenser according to claim 3, wherein the stiffness function comprises two parts for processing including a composite bending moment acting on an end of each of the laminated structures and a final curvature of each of the laminated structures are respectively processed.

5. The method for molding the revolution paraboloid condenser according to claim 1, wherein the uppermost layers of the laminated structures are working surfaces.

6. The method for molding the revolution paraboloid condenser according to claim 1, wherein the basic thin plate units are cut by a water jet cutter.

7. The method for molding the revolution paraboloid condenser according to claim 1, wherein the basic thin plate units that regularly change are connected by bonding with epoxy resin.

8. The method for molding the revolution paraboloid condenser according to claim 1, wherein the highly reflective material is a 3M ESR high-reflectivity double-sided silver reflection optical film.

9. The method for molding the revolution paraboloid condenser according to claim 1, wherein the number of the laminated structures is equal to or greater than six.

10. The method for molding the revolution paraboloid condenser according to claim 1, wherein the number of the basic thin plate units is equal to or greater than three.
